(19) United States
(12) Patent Application Publication
(10) Pub. No.: US 2015/0264703 A1
(43) Pub. Date: Sep. 17, 2015

(54) Method for Interference Management and Mitigation for LTE-M

(71) Applicant: Nokia Solutions and Networks Oy, Espoo (FI)

(72) Inventors: Rapeepat Ratasuk, Hoffman Estates, IL (US); Nitin Mangalvedhe, Hoffman Estates, IL (US); Amitabha Ghosh, Buffalo Grove, IL (US); Benny Vejlgaard, Gistrup (DK)

(73) Assignee: Nokia Solutions and Networks Oy

(21) Appl. No.: 14/641,639

(22) Filed: Mar. 9, 2015

Related U.S. Application Data
(60) Provisional application No. 61/951,031, filed on Mar. 11, 2014.

(51) Int. Cl. H04W 72/12

(52) U.S. Cl. CPC H04W 72/1215

(57) ABSTRACT

A network element of a first radio access technology system receives scheduling information for using resources in a second radio access technology system. Based on the scheduling information for using the resources in the second radio access technology system, the network element of the first radio access technology system is scheduled to use the resources in the second radio access technology system. The network element of the first radio access technology system transmits utilizing the resources in the second radio access technology system. Further aspects provide for scheduling based on building an interference profile map of the second radio access technology system created from the scheduling information. Other aspects detail additional attributes to determine the scheduling and/or go into or augment the interference profile map so as to determine the scheduling.

### TECHNICAL FIELD

This invention relates generally to the provision of a new narrowband LTE system to support machine-type communications (MTC) or machine-to-machine communications (M2M).

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section. Acronyms used in the drawings and this disclosure are defined at the end of this disclosure.

The following abbreviations that may be found in the specification and/or the drawing figures are defined as follows:

2G second generation

3G third generation

3GPP third generation partnership project

AS access stratum

BSC base station controller

BTS base transceiver station

CM connection management

CN core network

CQI channel quality indicator

CS circuit switched

CSI channel state information

DL downlink

DRMS demodulation reference signal

DTM dual transfer mode

eICIC enhanced inter cell interference coordination

EDGE enhanced data rates for GSM evolution

eNB or eNodeB evolved Node B (LTE base station)

EPDCCH enhanced physical downlink control channel

E-UTRAN evolved UTRAN

FER frame error rate

GERAN GSM EDGE radio access network

GGSN gateway GPRS support node

GMM GPRS mobility management

GMSC gateway MSC

GPRS general packet radio service

GSM global system for mobile communications

GW gateway

HLR home location register

HO handover

HSS home subscriber server

HTTP hypertext transfer protocol

IE information element

IMS IP multimedia subsystem

IP Internet protocol

L1 physical layer, also termed PHY

LTE long term evolution

LTE-A long term evolution—advanced

LTE-M LTE system to support MTC or M2M

Node B (NB) Node B (base station in UTRAN)

M2M machine-to-machine communications

MAC medium access control

MIMO multiple in, multiple out

MM mobility management

MME mobility management entity

MSC mobile switching center

MTC machine-type communications

NAS non access stratum

NCE network control entity/element

NCT new carrier type

NZP non-zero power

PCRF policy control and charging rules function

PDCP packet data convergence protocol

PDN-GW packet data network-gateway

PDSCH physical downlink shared channel

PMI precoding matrix indicator

PRB physical resource block

PSTN public switched telephone network

PS packet switched

PUSCH physical uplink shared channel

RAB radio access bearer

RAN radio access network

RAT radio access technology

RAU routing area update

RB radio bearer

RE resource element

Rel release

RI rank Indicator

RLC radio link control

RNC radio network controller

RR radio resource

RRC radio resource control

RS reference signal

SGSN serving GPRS support node

SGW serving gateway

SINR signal to interference plus noise ratio

SMC security mode command

SNR signal-to-noise ratio

SRB signaling radio bearer

SRVCC single radio voice call continuity

TDM time-division multiplexing

TS technical specification

Tx or tx transmission or transmitter

TS technical standard

UE user equipment

UL uplink

ULA uniform linear array

UMTS universal mobile telecommunications system

UTRAN universal terrestrial radio access network

VoIP voice over IP 3GPP

ZP zero power

There are several prior art references related to dynamic reuse of the spectrum between GSM and LTE. For instance, US 20130308595 proposes to deploy LTE using NCT with overlapping BW to GSM. Then, when GSM is not used, to schedule LTE transmission. Another example is US 20130294415, which is proposing to user carrier aggregation with information regarding availability of spectrum blocks shared between the first and second communication systems. These references are, however, related to reuse of GSM spectrum for LTE when there is no GSM transmission. No coexistence techniques such as power difference, effect of interference on SINR, partial overlapping, and interference cancellation were considered.

Another related prior art reference, which tries to optimally select GSM and LTE bandwidth, is EP2203011, which proposes to, based on load (e.g. number of mobiles), allocate appropriate bandwidth to LTE and GSM.

These prior art references are related to either re-farming of GSM spectrum or dynamic spectrum assignment of LTE/GSM, but not to coexistence when LTE-M is deployed next to or within GSM spectrum.

### SUMMARY

In broad terms, there is an interest in enhanced coverage for MTC with special focus on smart meter devices requiring up to 20 dB additional coverage from a reference LTE system, low cost devices with minimal complexity, and UEs with very minimal power consumption such that they could operate over very long time periods without changing batteries.

The invention described herein is directed at a method for interference management and mitigation for LTE-M.

In an example of an embodiment, a method is disclosed that includes receiving, by a network element of a first radio access technology system, scheduling information for using resources in a second radio access technology system; based on the scheduling information for using the resources in the second radio access technology system, scheduling the network element of the first radio access technology system for using the resources in the second radio access technology system; and transmitting by the network element of the first radio access technology system using the resources in the second radio access technology system.

An additional example of an embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer.

An example of an apparatus includes one or more processors and one or more memories including computer program code. The one or more memories and the computer program code are configured to, with the one or more processors, cause the apparatus to perform or control at least the following: receiving, by a network element of a first radio access technology system, scheduling information for using resources in a second radio access technology system; based on the scheduling information for using the resources in the second radio access technology system, scheduling the network element of the first radio access technology system for using the resources in the second radio access technology system; and transmitting by the network element of the first radio access technology system using the resources in the second radio access technology system.

An example of a computer program product includes a computer-readable storage medium bearing computer program code embodied therein for use with a computer. The computer program code includes: code for receiving, by a network element of a first radio access technology system, scheduling information for using resources in a second radio access technology system; based on the scheduling information for using the resources in the second radio access technology system, code for scheduling the network element of the first radio access technology system for using the resources in the second radio access technology system; and code for transmitting by the network element of the first radio access technology system using the resources in the second radio access technology system.

In another example of an embodiment, an apparatus comprises means for receiving, by a network element of a first radio access technology system, scheduling information for using resources in a second radio access technology system; based on the scheduling information for using the resources in the second radio access technology system, means for scheduling the network element of the first radio access technology system for using the resources in the second radio access technology system; and means for transmitting by the network element of the first radio access technology system using the resources in the second radio access technology system.

### BRIEF DESCRIPTION OF THE DRAWINGS

In the attached Drawing, the following figures are presented to explain the invention:

FIG. 1 is a block diagram of an exemplary system in which the exemplary embodiments may be practiced;

FIG. 2 shows a block diagram a portion of a wireless system embodiment;

FIG. 3 is a diagram of Narrowband LTE-M (180 kHz).

FIG. 4 is a diagram of LTE-M coexistence with GSM.

FIG. 5 is composed of FIGS. 5a and 5b which are graphs of SINR degradation due to LTE-M/GSM coexistence.

FIG. 6 is a diagram of LTE-M coexistence with GSM—extra guard band.

FIG. 7 is a logic flow diagram illustrating the operation of an exemplary method, a result of execution of computer program instructions embodied on a computer readable memory, and/or functions performed by logic implemented in hardware, in accordance with exemplary embodiments.

FIG. 8 is a diagram of channel allocation to GSM and LTE-M.

FIG. 9 is a diagram of cells affected by interference from adjacent channel.

FIG. 10 is a graph of PUSCH performance with power difference management.

FIG. 11 is a graph of PDSCH performance with scheduling low SINR user.

FIG. 12 is a logic flow diagram illustrating the operation of an exemplary method, a result of execution of computer program instructions embodied on a computer readable memory, and/or functions performed by logic implemented in hardware, in accordance with exemplary embodiments.

### DETAILED DESCRIPTION OF THE DRAWINGS

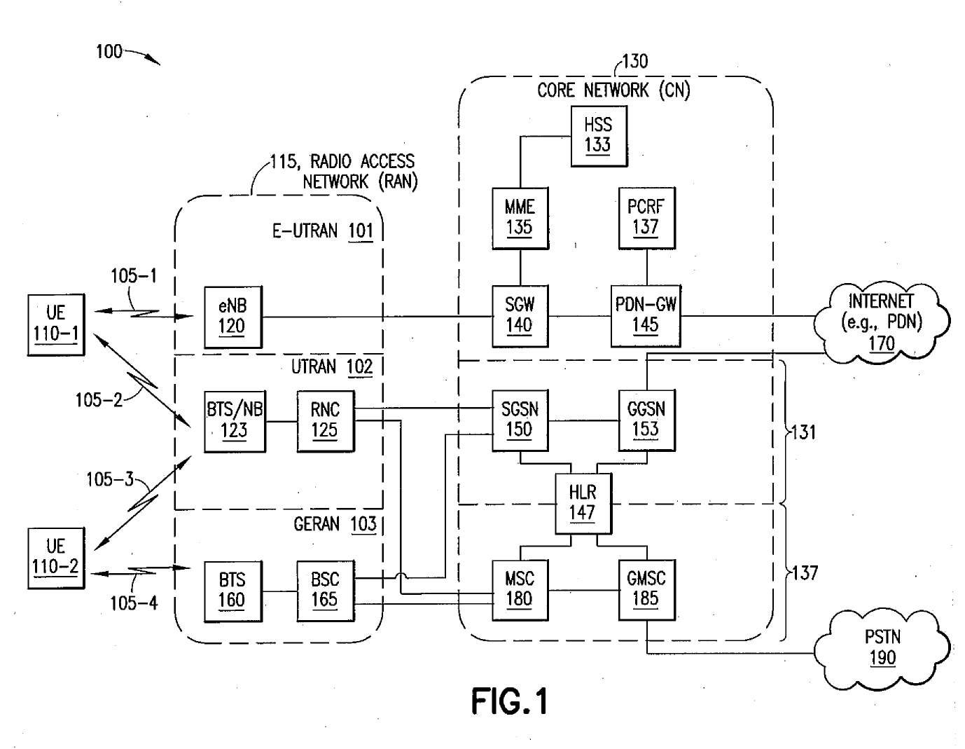

Before proceeding with additional description of problems and solutions herein to those problems, reference is made to FIG. 1, which shows a block diagram of an exemplary system in which the exemplary embodiments may be practiced.

FIG. 1 illustrates a block diagram of an exemplary wireless network into which the instant invention may be used, showing three systems, each having different radio access technologies: E-UTRAN 101, UTRAN 102, and GERAN 103. Each of these systems is roughly divided into a radio access network (RAN) 115 and a core network (CN) 130. For ease of explanation, the many connections between various entities in FIG. 1 are not discussed. Furthermore, the systems 101, 102, and 103 are merely representations for ease of exposition and are not to be construed as being limiting or exhaustive.

In an E-UTRAN embodiment, the RAN 115 includes an eNB (evolved Node B, also called E-UTRAN Node B) 120, and the CN 130 includes a home subscriber server (HSS) 133, a serving gateway (SGW) 140, a mobility management entity (MME) 135, a policy and charging rules function (PCRF) 137, and a packet data network gateway (PDN-GW) 145. E-UTRAN is also called long term evolution (LTE).

In a UTRAN embodiment, the RAN 115 includes a base transfer station (BTS) (Node B) 123 and a radio network controller 125, and the CN 130 includes a serving GPRS support node (SGSN) 150, a home location register (MLR) 147, and a gateway GPRS support node (GGSN) 153.

In a GERAN embodiment, the RAN 115 includes a BTS 160 and a base station controller (BSC) 165, and the CN 130 includes a mobile switching center (MSC) 180 and a gateway MSC (GMSC) 185. This example shows the HLR 147 as being part of both UTRAN and GERAN, but this is merely exemplary.

The GMSC 185 is connected to the PSTN 190. There is a circuit-switched core network (CS CN) 137, which includes the MSC 180 and the GMSC 185. Note that the RNC 125 of UTRAN and the BSC 165 of GERAN can both access the CS CN 137.

The PDN-GW 145 and the GGSN 153 connect to the Internet (or other packet data network) 170. There is a packet-switched core network (PS CN) 131, which includes the GGSN 153 and SGSN 150. Both the RNC 125 of UTRAN and the BSC 165 of GERAN can access the PS CN 131.

The example of FIG. 1 shows a UE 110-1 that is able to connect to both the E-UTRAN 101 and the UTRAN 102 via wireless links 105-1 and 105-2, respectively. UE 110-2 can connect to the UTRAN 102 and to the GERAN 103 via wireless links 105-3 and 105-4, respectively. Exemplary embodiments herein may apply to both handovers from E-UTRAN 101 to UTRAN 102 and also from GERAN 103 to UTRAN 102.

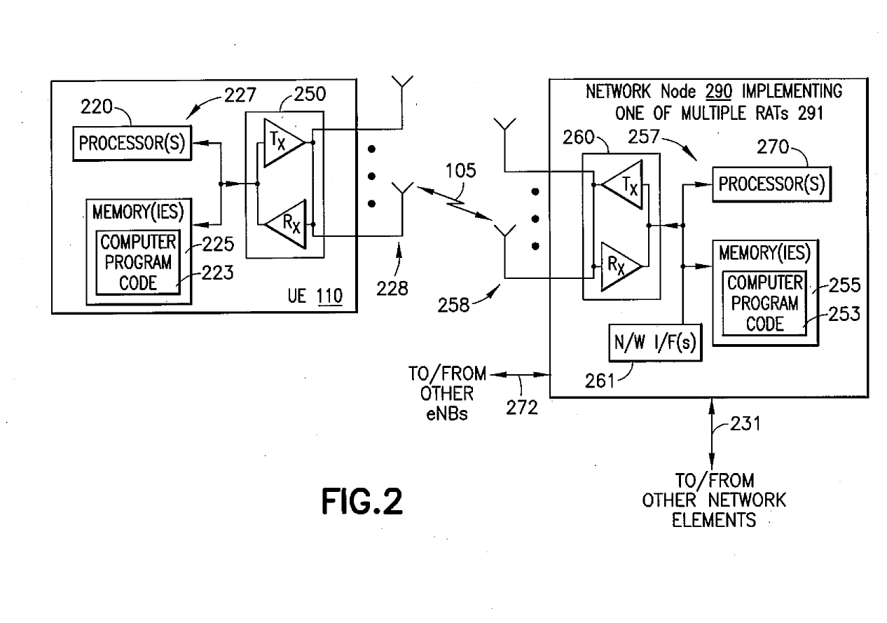

Turning to FIG. 2, this figure shows a block diagram a portion of the wireless system 100. In FIG. 2, a UE 110 is in wireless communication via a wireless link 105 with a network node 290 of wireless network 100. The user equipment 110 includes one or more processors 220, one or more memories 225, and one or more transceivers 250 interconnected through one or more buses 227. The one or more transceivers 250 are connected to one or more antennas 228. The one or more memories 225 include computer program code 223. The one or more memories 225 and the computer program code 223 are configured, with the one or more processors 220, to cause the user equipment 210 to perform one or more of the operations as described herein.

The network node 290 may be one of the RAN network nodes in the RAN 115 for the various systems E-UTRAN 101, UTRAN 102, GERAN 103, and may implement one or more RATs 291 corresponding to an appropriate system 101, 102, or 103. A RAT is a means for a UE to access a wireless network and includes appropriate air interfaces (e.g., spectrums, coding, channels, spreading, physical resources in time, frequency, or codes) for LTE, UMTS, GSM, CDMA, and the like. The network node 290 includes one or more processors 270, one or more memories 255, one or more network interfaces (N/W I/F(s)) 261, and one or more transceivers 260 interconnected through one or more buses 257. The one or more transceivers 260 are connected to one or more antennas 258. The one or more memories 255 include computer program code 253. The one or more memories 255 and the computer program code 253 are configured, with the one or more processors 250, to cause the network node 290 to perform one or more of the operations as described herein. The one or more network interfaces 261 communicate over a network such as the networks 272 and 231. Two or more base stations communicate using, e.g., network 270. The network 272 may be wired or wireless or both. The network 231 may be wired or wireless or both may be used to communicate with other network elements.

The computer readable memories 225 and 255 may be of any type suitable to the local technical environment and may be implemented using any suitable data storage technology, such as semiconductor based memory devices, flash memory, magnetic memory devices and systems, optical memory devices and systems, fixed memory and removable memory. The processors 220 and 270 may be of any type suitable to the local technical environment, and may include one or more of general purpose computers, special purpose computers, microprocessors, digital signal processors (DSPs) and processors based on a multi-core processor architecture, as non-limiting examples.

In general, the various embodiments of the user equipment 110 can include, but are not limited to, cellular telephones such as smart phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions, and additionally MTC devices such as smart meters, remote sensors and monitors, and commercial/consumer devices.

LTE-M can focus on serving low data-rate and wide area M2M services such as smart meters, remote sensors and monitors, and commercial/consumer devices. Smart meters may include electricity, gas, and water meters. Remote sensors and monitors may include sensors, vending machine control, vehicle diagnostics, health monitors, traffic sensor, roadway signs, and traffic lights. Commercial/consumer devices may include credit machines, vending machines, appliances, e-books, etc. To address this space, 3GPP has identified the following features for supporting M2M services—low mobility, time controlled, small data transmissions, infrequent mobile terminated, monitoring, secure connection, and group-based policing and addressing.

Embodiments herein may be implemented in software (executed by one or more processors), hardware (e.g., an application specific integrated circuit), or a combination of software and hardware. In an exemplary embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 171 or other device) that may be any media or means that can contain or store the instructions for use by or in connection with an instruction execution system, apparatus, or device, such as a computer.

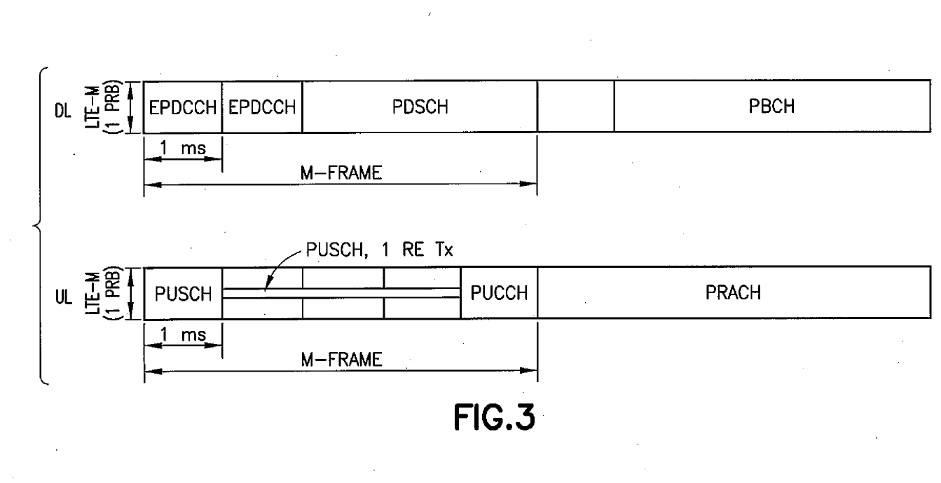

Regarding FIG. 3, the lowest supportable bandwidth at the time of this invention for LTE is 1.4 MHz. LTE operation in narrowband is being considered in order to decrease device cost and improve system coverage. This new narrowband MTC system is tentatively termed LTE-M. Deploying LTE-M in 200 kHz in order to re-farm GSM spectrum is being studied. Deploying LTE-M using only 1 PRB (180 kHz) is shown in FIG. 3, which is directed to a diagram for Narrowband LTE-M (180 kHz), where the occupied bandwidth of the LTE-M system is 180 kHz which allows it to fit into an existing GSM channel. LTE-M becomes a TDM system where different channels are time-multiplexed together.

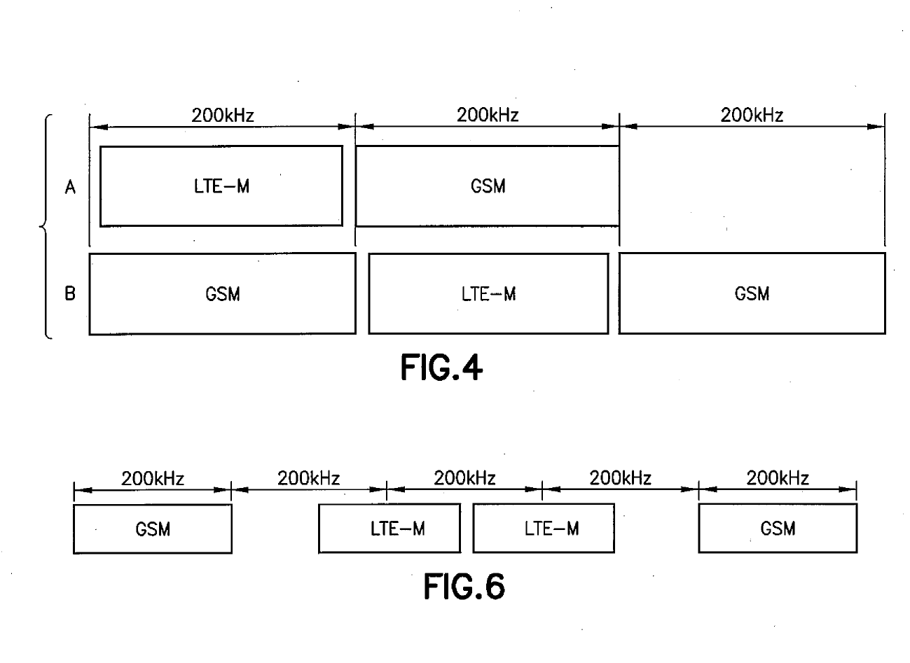

FIG. 4 depicts LTE-M coexistence with GSM. With the deployment of LTE-M through re-farming of GSM spectrum, coexistence is a concern. Some coexistence deployment scenarios are shown in FIG. 4. In scenario A, LTE-M is next to one GSM channel, while in scenario B, LTE-M is adjacent to two GSM channels

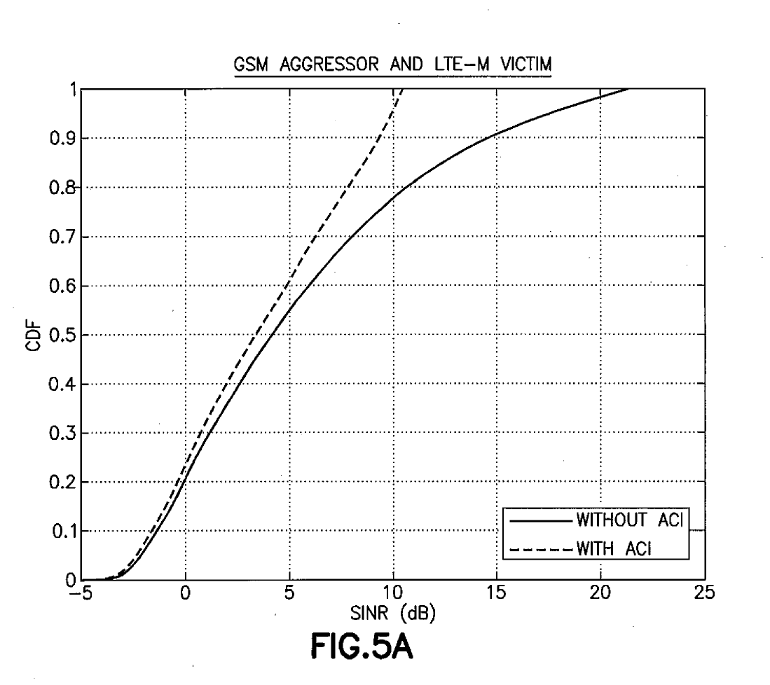

SINR degradation due to LTE-M/GSM coexistence is examined in FIG. 5. Our analysis shows that when LTE-M is adjacent to GSM, then interference is high because the guard band is very small (only 10 kHz). This results in SINR degradation for both systems as shown in FIG. 5. In FIG. 5(a), SINR degradation for LTE-M is shown while in FIG. 5(b), SINR degradation for GSM is shown. From the figure, it is seen that SINR degradation is worse for GSM system. This is because GSM is deployed using a reuse factor greater than one whereas LTE-M is deployed using a reuse factor of one. As a result, GSM channels that are adjacent to LTE-M channels will suffer disproportionate amount of interference.

From FIG. 5, it can be observed that SINR degradation is most severe for high SINR users because they are interference-limited (e.g. ˜6 dB reduction for LTE-M user in the 90%-tile). For low SINR users, degradation is small (e.g. ˜0.1 dB reduction for LTE-M user in the 10%-tile).

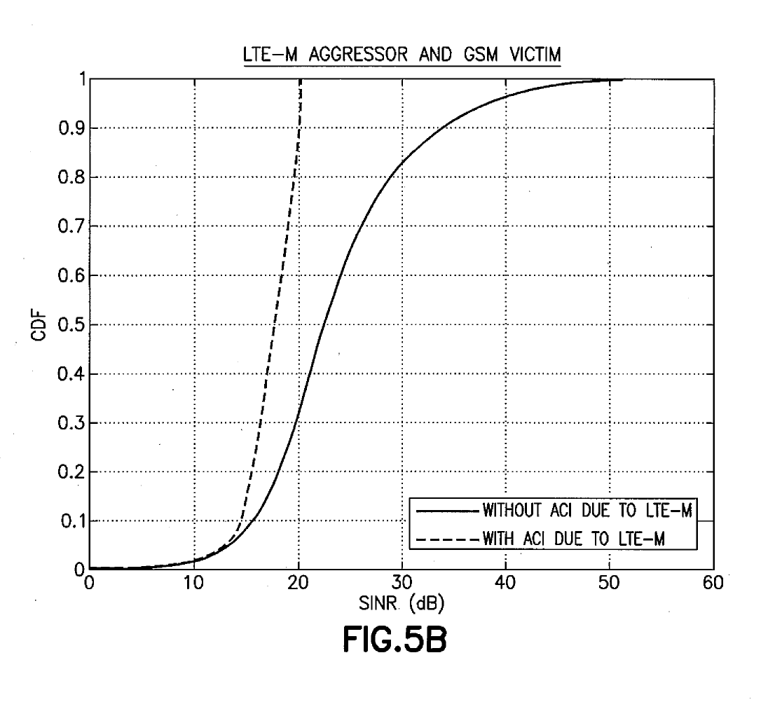

FIG. 6 shows LTE-M coexistence with GSM—extra guard band, as one way to fix this problem is to use additional guard band. For example, 2 GSM channels can be used to deploy 1 LTE-M channel, adding additional guard bands of 100 kHz on each side of LTE-M. The additional guard band reduces the amount of SINR degradation. In general, we found that (n+1) GSM channels can be used to deployed n LTE-M channels to have the same guard band.

This solution, however, wastes one GSM channel. From our capacity analysis, we found that one GSM channel can support a very large number of low-rate MTC devices (e.g. smart meters, sensors, monitoring devices, etc.) using LTE-M. This is a significant amount of wasted MTC capacity.

Thus, a method is required that can provide interference or coexistence coordination between LTE-M and GSM systems. This will allow LTE-M to be deployed adjacent to GSM without additional guard bands.

An embodiment of the present method of this invention employs GSM scheduling performed on a 20 ms basis. This means that channel usage, scheduled users, transmission power levels, MCS (modulation and coding scheme) selection and other relevant parameters are sent every 20 ms. This is in advance of the shorter scheduling time frame for LTE-M (e.g. 1 ms or longer). Thus, GSM scheduling information can be used to decide on LTE-M transmission. In addition, the GSM BSC may make scheduling determination on even longer basis (e.g. if interference coordination scheme or frequency hopping is used). Thus the GSM BSC make be able to provide scheduling information to LTE-M in advance of the 20 ms scheduling interval.

This invention allows performing intelligent LTE-M scheduling and user selection; for example, selecting an appropriate LTE-M/GSM user pairing ensures no large power difference, scheduling LTE-M when GSM is not used, not scheduling LTE if it will cause unacceptable interference with GSM, scheduling only LTE users with low SINR together with GSM users since they are noise-limited and not impacted much by interference.

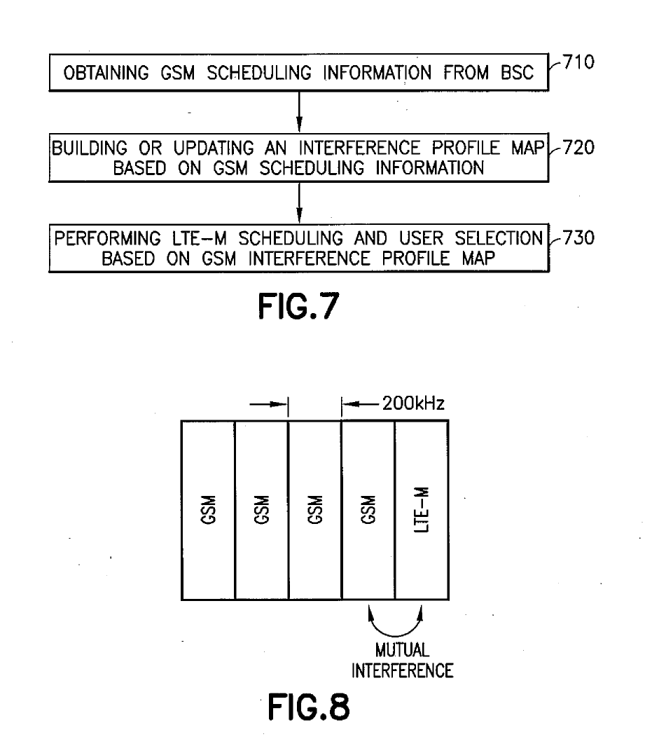

FIG. 7 is a logic flow diagram illustrating the operation of an exemplary method, a result of execution of computer program instructions embodied on a computer readable memory, and/or functions performed by logic implemented in hardware, in accordance with exemplary embodiments. Each block of the flow diagram could be interpreted as interconnecting means performing the functions described therein.

Such a method as envisioned herein would comprise the following: obtaining GSM scheduling information from BSC 710; building or updating an interference profile map based on GSM scheduling information 720; and performing LTE-M scheduling and user selection based on the GSM interference profile map 730.

Regarding obtaining GSM scheduling information from BSC, GSM scheduling information may be as simple as channel assignment in the next frame or can include additional information such as transmission power, MCS (modulation and coding scheme), selected users, pathloss, transmission type, receiver type, and channel quality of selected users. In addition, information about locations of GSM base-stations relative to LTE-M eNBs may be used to build the interference profile.

Note that GSM is typically deployed using a reuse pattern, so only scheduling information from nearby BTSs that use the immediately adjacent channels to LTE-M is required. For example, if reuse factor of 4 is used for GSM, then this information is needed from every 4th BTS in deployment scenario A of FIG. 4.

FIG. 8, labeled Channel allocation to GSM and LTE-M, shows the allocation of four adjacent channels to GSM and a fifth channel adjacent to the last GSM channel.

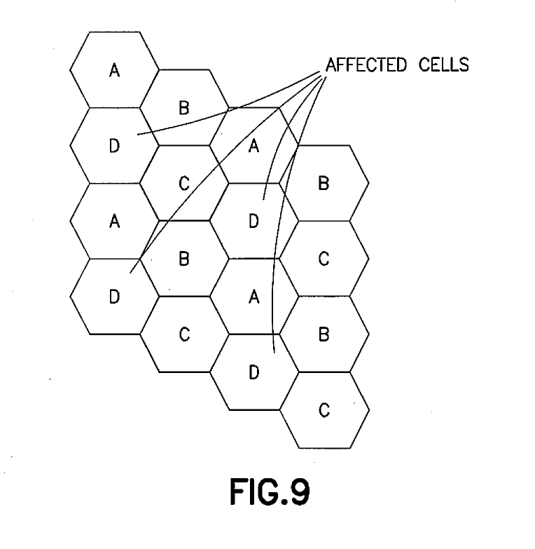

FIG. 9, entitled cells affected by interference from adjacent channel, illustrates GSM cells reusing the same frequency (the same frequency is used in all LTE-M cells) and the cells affected by adjacent channel interference from LTE-M (where the scheduling information is needed) are labeled.

Building or updating an interference profile map based on GSM scheduling information can include, for example, expected adjacent channel interference level in each LTE-M subframe within the GSM slot, how much adjacent channel interference due to LTE-M the GSM users can tolerate (e.g. low SINR GSM users can tolerate much more interference since they are noise-limited), GSM transmission type in each LTE-M subframe (voice or data), receiver type (e.g. if LTE-M interference cancellation or rejection is available), and transmission power level.

Performing LTE-M scheduling and user is selection based on GSM interference profile map. Example of scheduling decisions are as follows:

Schedule LTE-M when GSM is not used;

Select LTE-M/GSM user pairing to ensure there is no large power difference;

Power control to ensure comparable power difference between the two systems;

Not scheduling LTE-M if the resulting interference to GSM would be higher than a threshold, where the threshold may be dynamic depending on GSM scheduling information (e.g. low SINR GSM users can tolerate much more interference since they are noise-limited); the threshold can also be adapted to consider partial interference where only a portion of the slot is overlapping between LTE-M and GSM; and/or the threshold can also depend on GSM reuse pattern;

Schedule low SINR LTE-M users when interference from GSM is high;

Schedule LTE-M during GSM data slots and not voice slots;

Schedule LTE-M when GSM receiver has interference cancellation or interference rejection capability.

Note that the above inventive steps are considered from an LTE-M perspective (i.e. given GSM transmission, trying to minimize the impact of LTE-M to GSM and thus giving priority to GSM users). However, it is only one embodiment. The reverse consideration, i.e. considering interference from GSM perspective, can be done following the same principle.

Considering interference from GSM perspective, the following methods may be used: (1) if certain LTE-M devices are time controlled to access the network at specific times, this information can be conveyed to GSM to let the BSC schedule at appropriate times, (2) if the traffic pattern of LTE-M devices are known (e.g. smart meters may send report only every 2 hours), then the expected traffic and access time can be conveyed to GSM to let the BSC schedule at appropriate times, (3) information from the MTC server on pending transmissions to MTC devices can be conveyed to GSM to let the BSC schedule at appropriate times.

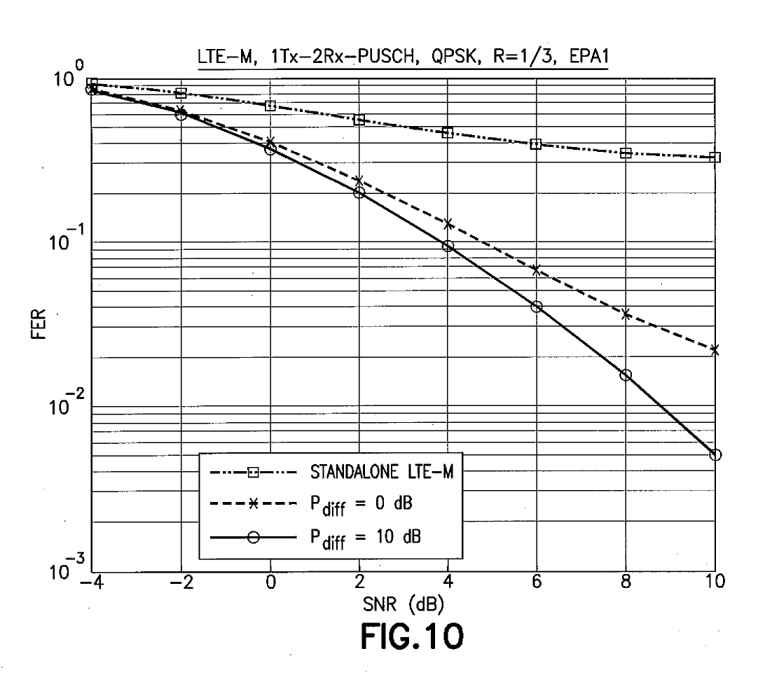

FIG. 10 illustrates PUSCH performance under coexistence when user pairing/power management is used for users with medium SNR. From the figure, it is seen that if the power difference is 10 dB (i.e. GSM PSD is 10 dB higher), then LTE-M performance is quite poor due to the strong interference degrading the SINR. However, if it is ensured that the power is comparable between the two systems, then performance degradation is small (approximately 1 dB at the 10% target FER). Although not shown, results are also similar for the downlink at similar operating SNR (4 dB in this case).

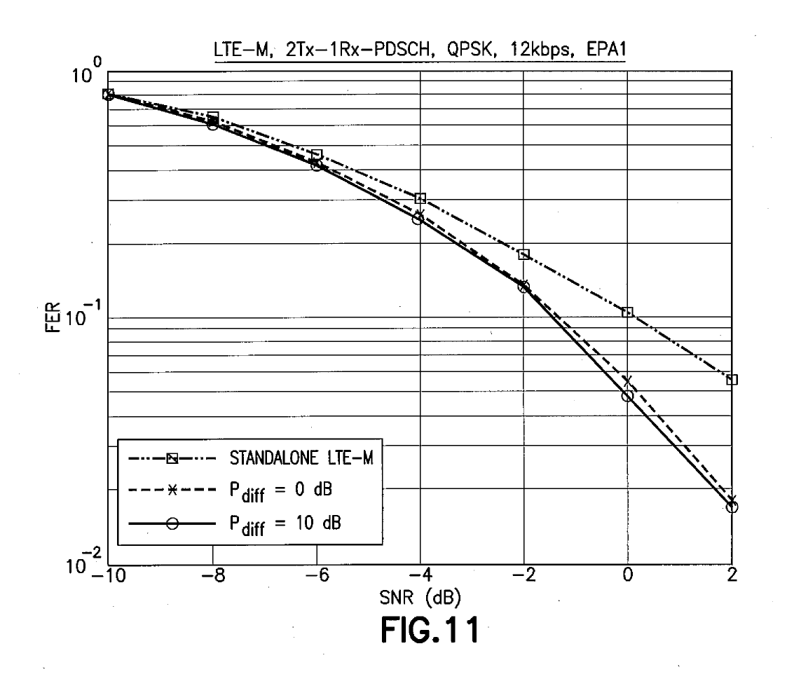

FIG. 11 illustrates PDSCH performance under coexistence when low SINR LTE-M user is scheduled when interference from GSM is high. From the figure, it is seen that even if the power difference is 10 dB (i.e. GSM PSD is 10 dB higher), then LTE-M performance degrades by only 1.5 dB at the 10% FER target. Note that in this case, performance degradation with 10 dB power difference is significantly better than shown in FIG. 10.

An advantage of this method is the ability to allow LTE-M to be deployed adjacent to GSM without additional guard bands. This means one additional LTE-M channel can be supported using the same number of GSM channels as before. From the results shown in FIG. 10 and FIG. 11, it is seen that, with knowledge of GSM interference profile, LTE-M scheduling decisions can be intelligently made to minimize the impact from interference.

Techniques for this type of coexistence management do not appear to exist as of the date of this invention. With respect to interference coordination techniques, this method is different from the traditional interference coordination techniques among LTE (e.g. eICIC or penalty-based power control).

In one embodiment of the invention, GSM is given first priority and scheduling for GSM is performed without regard to coexistence. This takes advantage of knowing GSM assignment in advance to perform interference mitigation and management for LTE-M.

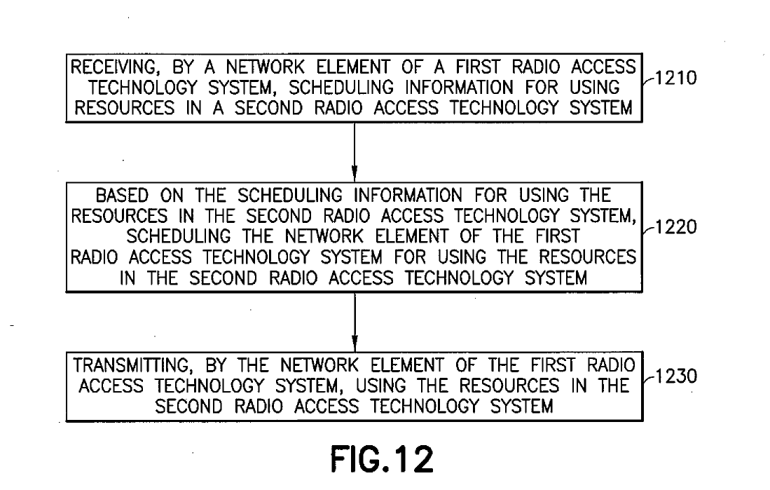

FIG. 12 is a logic flow diagram illustrating the operation of an exemplary method, a result of execution of computer program instructions embodied on a computer readable memory, and/or functions performed by logic implemented in hardware, in accordance with exemplary embodiments. Each block of the flow diagram could be interpreted as interconnecting means performing the functions described therein.

Such a method as envisioned herein would comprise the following steps: receiving, by a network element of a first radio access technology system, scheduling information for using resources in a second radio access technology system as shown in block 1210; based on the scheduling information for using the resources in the second radio access technology system, scheduling the network element of the first radio access technology system for using the resources in the second radio access technology system as shown in block 1220; and transmitting, by the network element of the first radio access technology system using the resources in the second radio access technology system as shown in block 1230.

Thus, FIG. 12 is an example of an embodiment, which can be referred to as item 1, as a method comprising: receiving, by a network element of a first radio access technology system, scheduling information for using resources in a second radio access technology system; based on the scheduling information for using the resources in the second radio access technology system, scheduling the network element of the first radio access technology system for using the resources in the second radio access technology system; and transmitting, by the network element of the first radio access technology system, using the resources in the second radio access technology system.

An example of a further embodiment, which can be referred to as item 2, is the method of item 1 wherein the scheduling is based on a second radio access technology system interference profile map built from the scheduling information. Or, in other words, an interference profile map, of the second radio access technology system, is created using the scheduling information and the scheduling is then determined based on that map. As discussed below in other embodiments, there may be additional attributes that go into determining the scheduling and/or which could go into or augment the interference profile map so as to determine the scheduling.

An example of a further embodiment, which can be referred to as item 3, is the method of item 1 wherein the first radio access technology is LTE-M, M2M, or MTC.

An example of a further embodiment, which can be referred to as item 4, is the method of item 1 wherein the second radio access technology is GSM.

An example of a further embodiment, which can be referred to as item 5, is the method of item 1 wherein the scheduling information comprises at least one of the following: channel assignment in a next frame, transmission power level, modulation and coding scheme, selected users, pathloss, transmission type, receiver type, and channel quality of selected users.

An example of a further embodiment, which can be referred to as item 6, is the method of item 2 wherein building the system interference profile map comprises at least one of the following: information about locations of second radio access technology base stations relative to first radio access technology base stations, expected adjacent channel interference level in each first radio access technology subframe within a second radio access technology slot, an amount of adjacent channel interference due to the first radio access technology that a user of the second radio access technology can tolerate, a second radio access technology transmission type in each first radio access technology subframe, receiver type, and transmission power level.

An example of a further embodiment, which can be referred to as item 7, is the method of item 2 wherein the scheduling is further based on limiting to times when second radio access technology is not used.

An example of a further embodiment, which can be referred to as item 8, is the method of item 2 wherein the scheduling is further based on selecting a first radio access technology system/second radio access technology user pairing to ensure there is no power difference greater than a predetermined value.

An example of a further embodiment, which can be referred to as item 9, is the method of item 2 wherein the scheduling is further based on determining power control to ensure comparable power difference between the first radio access technology system and the second radio access technology system.

An example of a further embodiment, which can be referred to as item 10, is the method of item 2 wherein the scheduling is further based on not scheduling the first radio access technology system if a resulting interference to the second radio access technology would be higher than a threshold, wherein the threshold is determined by at least one of the following: dynamically based on second radio access technology scheduling information, considering partial interference, wherein only a portion of a slot is overlapping between the first radio access technology system and the second radio access technology system, and a second radio access technology reuse pattern.

An example of a further embodiment, which can be referred to as item 11, is the method of item 2 wherein the scheduling is further based on scheduling low SINR first radio access technology system users when interference from second radio access technology is higher than a value.

An example of a further embodiment, which can be referred to as item 12, is the method of item 2 wherein the scheduling is further based on scheduling first radio access technology system during second radio access technology data slots and not voice slots.

An example of a further embodiment, which can be referred to as item 13, is the method of item 2 wherein the scheduling is further based on scheduling first radio access technology system when second radio access technology receiver has interference cancellation or interference rejection capability.

An example of a further embodiment, which can be referred to as item 14, is the method of item 2 wherein the system interference map is updated with received scheduling information.

An example of a further embodiment, which can be referred to as item 15, is the method of item 1 wherein the scheduling is performed by a base station controller of the second radio access technology.

An example of a further embodiment, which can be referred to as item 16, is the method of item 15 further comprising: conveying specific times to the base station controller for scheduling limited to the specific times in response to at least one of the following: the network element of the first radio access technology being time controlled to only access the second radio access technology system at the specific times, a traffic pattern of first radio access technology system allowing access at only the specific times, and information from a server of the first radio access technology system on pending transmissions to first radio access technology devices at the specific times which can be conveyed to second radio access technology.

An example of a further embodiment, which can be referred to as item 17, is the method of item 1 wherein the scheduling for second radio access technology is performed without regard to coexistence.

An example of a further embodiment, which can be referred to as item 18, is the method of item 17 wherein the resources of the second radio access technology system are predetermined.

Any of methods herein can be implemented or performed as a result of execution of computer program instructions embodied on a computer readable memory, and/or functions performed by logic implemented in hardware, in accordance with the exemplary embodiments. Moreover, each step of any method above could be practiced as interconnecting means performing the functions described therein.

For example, an apparatus comprising at least one processor and at least one memory including computer program code, wherein the at least one memory and the computer code are configured with the at least one processor, to cause the apparatus to at least perform the any of the methods disclosed herein can serve as an embodiment of this invention.

For another example, a computer program product embodied on a non-transitory computer-readable medium, in which a computer program is stored which, when being executed by a computer, is configured to provide instructions to control or carry out any of the methods disclosed herein can also serve as an embodiment of this invention.

Examples of additional embodiments can involve an apparatus that at least has the means to perform or control any of the methods described herein.

If desired, the different functions discussed herein may be performed in a different order and/or concurrently with each other. Furthermore, if desired, one or more of the above-described functions may be optional or may be combined.

Although various aspects are set out above, other aspects comprise other combinations of features from the described embodiments, and not solely the combinations described above.

It is also noted herein that while the above describes examples of embodiments of the invention, these descriptions should not be viewed in a limiting sense. Rather, there are several variations and modifications which may be made without departing from the scope of the present invention.

Without in any way limiting the scope, interpretation, or application of the claims appearing herein, a technical effect of one or more of the examples of embodiments disclosed herein is to have enhanced coverage for MTC improved performance for interference management and mitigation for LTE-M. Another technical effect of one or more of the examples of embodiments disclosed herein is improved system to system efficiency than if the embodiments described herein are not utilized.

We claim:

1. A method, comprising:
receiving, by a network element of a first radio access technology system, scheduling information for using resources in a second radio access technology system;
based on the scheduling information for using the resources in the second radio access technology system, scheduling the network element of the first radio access technology system for using the resources in the second radio access technology system; and
transmitting, by the network element of the first radio access technology system, using the resources in the second radio access technology system.

2. The method of claim 1, wherein the scheduling is based on a second radio access technology system interference profile map built from the scheduling information.

3. The method of claim 1, wherein the first radio access technology is LTE-M, M2M, or MTC.

4. The method of claim 1, wherein the second radio access technology is GSM.

5. The method of claim 1, wherein the scheduling information comprises at least one of the following:
channel assignment in a next frame,
transmission power level,
modulation and coding scheme,
selected users,
pathloss,
transmission type,
receiver type, and
channel quality of selected users.

6. The method of claim 2, wherein building the system interference profile map comprises at least one of the following:
information about locations of second radio access technology base stations relative to first radio access technology base stations,
expected adjacent channel interference level in each first radio access technology subframe within a second radio access technology slot,
an amount of adjacent channel interference due to the first radio access technology that a user of the second radio access technology can tolerate,
a second radio access technology transmission type in each first radio access technology subframe,
receiver type, and
transmission power level.

7. The method of claim 2, wherein the scheduling is further based on limiting to times when second radio access technology is not used.

8. The method of claim 2, wherein the scheduling further is further based on selecting a first radio access technology system/second radio access technology user pairing to ensure there is no power difference greater than a predetermined value.

9. The method of claim 2, wherein the scheduling is further based on determining power control to ensure comparable power difference between the first radio access technology system and the second radio access technology system.

10. The method of claim 2, wherein the scheduling further is further based on not scheduling the first radio access technology system if a resulting interference to the second radio access technology would be higher than a threshold, wherein the threshold is determined by at least one of the following:
dynamically based on second radio access technology scheduling information,
considering partial interference, wherein only a portion of a slot is overlapping between the first radio access technology system and the second radio access technology system, and
a second radio access technology reuse pattern.

11. The method of claim 2, wherein the scheduling is further based on scheduling low SINR first radio access technology system users when interference from second radio access technology is higher than a value.

12. The method of claim 2, wherein the scheduling is further based on scheduling first radio access technology system during second radio access technology data slots and not voice slots.

13. The method of claim 2, wherein the scheduling is further based on scheduling first radio access technology system when second radio access technology receiver has interference cancellation or interference rejection capability.

14. The method of claim 2, wherein the system interference map is updated with received scheduling information.

15. The method of claim 1, wherein the scheduling is performed by a base station controller of the second radio access technology.

16. The method of claim 15, further comprising:
conveying specific times to the base station controller for scheduling limited to the specific times in response to at least one of the following:
the network element of the first radio access technology being time controlled to only access the second radio access technology system at the specific times,
a traffic pattern of first radio access technology system allowing access at only the specific times, and
information from a server of the first radio access technology system on pending transmissions to first radio access technology devices at the specific times which can be conveyed to second radio access technology.

17. The method of claim 1, wherein the scheduling for second radio access technology is performed without regard to coexistence.

18. The method of claim 17, wherein the resources of the second radio access technology system are predetermined.

19. An apparatus comprising:
at least one processor and at least one memory including computer program code, wherein the at least one memory and the computer code are configured, with the at least one processor, to cause the apparatus to at least perform or control the following:
receiving scheduling information for using resources in a radio access technology system different from the radio access technology system of the apparatus;
based on the scheduling information for using the resources in the different radio access technology system, scheduling the apparatus for using the resources in the different radio access technology system; and
transmitting by the apparatus using the resources in the different radio access technology system.

20. A computer program product embodied on a non-transitory computer-readable medium in which a computer program is stored that, when being executed by a computer, is configured to provide instructions to control or carry out:
receiving, by a network element of a first radio access technology system, scheduling information for using resources in a second radio access technology system;
based on the scheduling information for using the resources in the second radio access technology system, scheduling the network element of the first radio access technology system for using the resources in the second radio access technology system; and
transmitting, by the network element of the first radio access technology system, using the resources in the second radio access technology system.
